(19) United States
(12) Patent Application Publication
(10) Pub. No.: US 2018/0293681 A1
(43) Pub. Date: Oct. 11, 2018

(54) AUTOMATED BACKGROUND CHECKS

(71) Applicant: Criminal Justice DNA, LLC, Spokane, WA (US)

(72) Inventors: Gavin LAROWE, Spokane, WA (US); Michael CABACUNGAN, SR., Port Orchard, WA (US)

(21) Appl. No.: 15/950,091

(22) Filed: Apr. 10, 2018

Related U.S. Application Data
(60) Provisional application No. 62/484,225, filed on Apr. 11, 2017.

(51) Int. Cl. G06Q 50/26; G06F 17/30; G06Q 50/00

(52) U.S. Cl. CPC G06Q 50/26; G06Q 50/01; G06F 17/30876

(57) ABSTRACT

Background checks are a typical part of the hiring process. In the case of public safety employees, such as police officers, firemen and firewomen, and the like, employers have sought ever more comprehensive background checks. Even for non-public safety employees, such as teachers and child volunteers, improved background check techniques to reduce employment liability continue to be desirable. An improved automated background check process is disclosed that makes use of information about applicants from third party sources such as social networks, and online internet based information. An application process which performs autocomplete and on the fly validation and corroboration is described. Specifically, a rules engine with rules to validate representations made by applicants are corroborated against other applications as well as these third party sources of information. Reporting on applicants, auditing and administrative functions are also disclosed.

### CROSS REFERENCE TO RELATED PATENT APPLICATION

This application claims priority to U.S. Provisional Patent Application No. 62/484,225, filed on Apr. 11, 2017, entitled “AUTOMATED BACKGROUND CHECKS,” which is hereby incorporated by reference in its entirety.

### BACKGROUND

A person typically completes and submits an application when applying for employment or for some other position. The potential employer will then review the application to determine the suitability and fitness of the applicant. In doing so, the potential employer will not merely rely on the representations made by the applicant, but will perform an investigation, called a background check, to corroborate those representations.

Where the person is applying for a position of great sensitivity, background checks may be rather comprehensive. For example, the review of a law enforcement candidate may take two weeks or more of full time work by a law enforcement officer, where the officer not only reviews the application, but interviews persons knowledgeable about the candidate, and actively investigates any indication of potential unsuitability or unfitness of the candidate. Similar issues exist with respect to fire departments, teachers, regulatory workers, and the application processes of any sensitive job.

The more sensitive the job, the more labor intensive the background check. However, the more labor intensive the job, the more costly the background check, and the harder it is to perform a thorough background check. Accordingly, there is a need to improve the effectiveness and efficiency of background checks.

### BRIEF DESCRIPTION OF THE DRAWINGS

The Detailed Description is set forth with reference to the accompanying figures.

FIG. 1 is a context diagram for Automated Background Checks.

FIG. 2 is a flow chart of an exemplary hardware, software and communications environment for Automated Background Checks.

FIG. 3 is an architectural diagram for Automated Background Checks internals.

FIG. 4 is a flow chart of an investigator using Automated Background Checks.

FIG. 5 is a flow chart of an administrator reviewing applications and rules for Automated Background Checks.

### DETAILED DESCRIPTION

### Context of Automated Background Checks

### Overview

Presently, a large amount of information about each individual person is available online. Some information is stored in official law enforcement databases, such as arrest records and records of other infractions. Other information is a record of transactions by a person such as the person buying a house or buying a gun. Yet other information is available as self-reported by the individual person via social media. All this information, and other information are available via such sources of information.

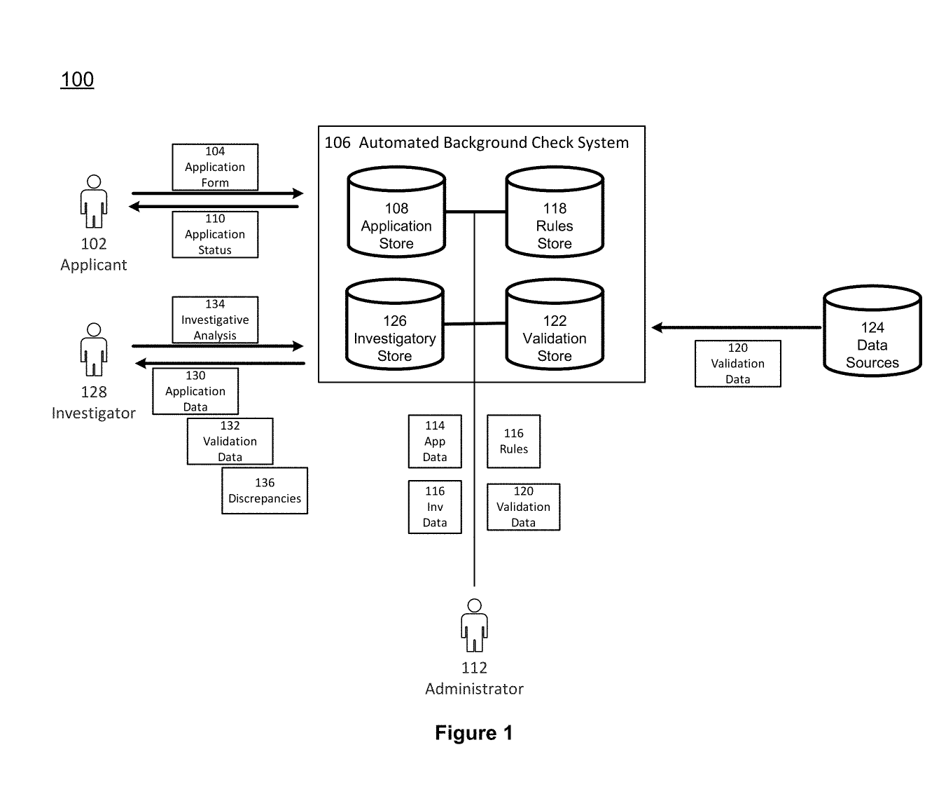

Automated Background Checks provides an infrastructure to correlate data in an application form of an applicant against online and other third party sources. Automated Background Checks receive an application form comprised of a plurality of fields, and the values as entered by an applicant. Based on rules stored in a rules engine, Automated Background Checks retrieve validation data from a source of information, such as an online source, and then auto-populate forms, and search for potential discrepancies between the application and the sources of information. Identified potential discrepancies are then reported to an investigator. FIG. 1 provides a context diagram 100 of this process.

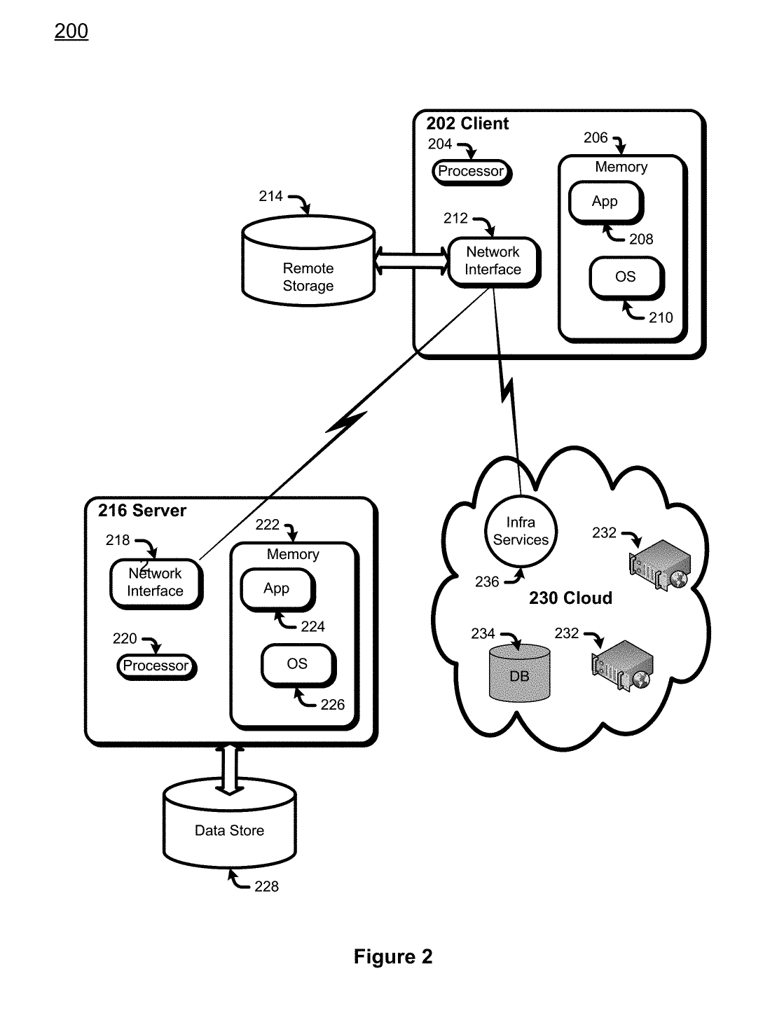

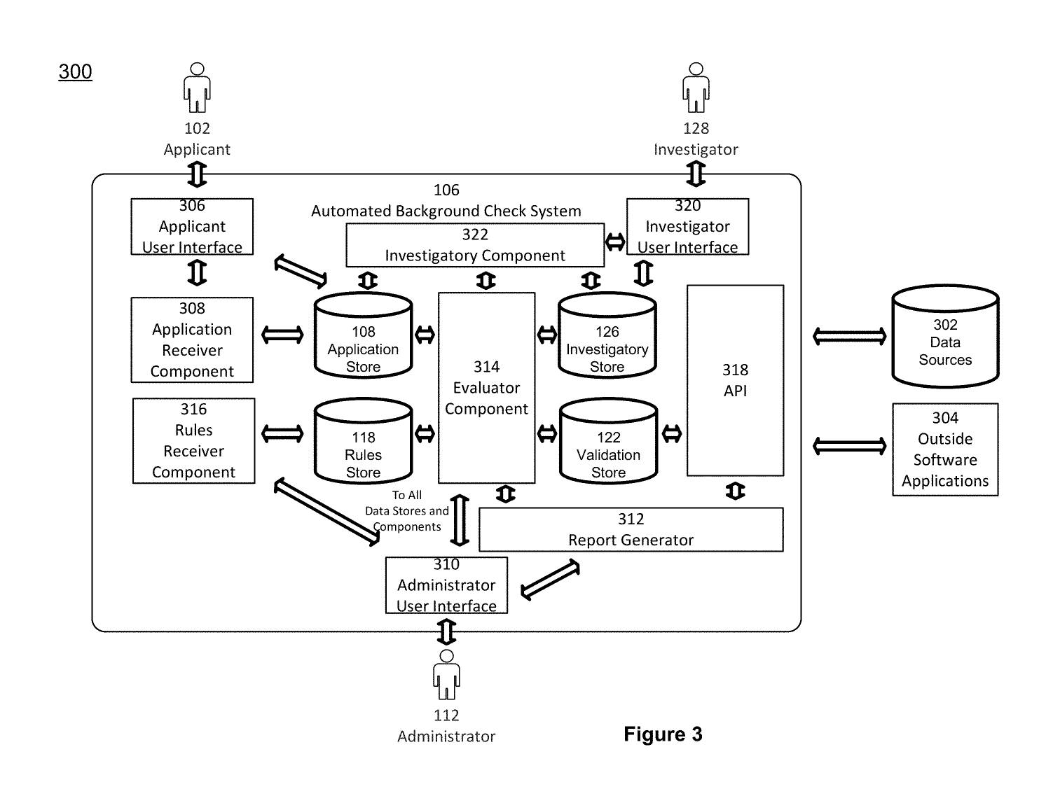

Applicant 102 submits an application form 104 to an Automated Background Check System (“ABCS”) 106 via an applicant user interface such as a software client or a web page. Software clients and web pages are described in further detail with respect to FIGS. 2 and 3 below. The application form 104 need not be a single sheet of paper, but can subsume multiple sub-forms. In some cases, the sub-forms need not be submitted at the same time. The application form 104 may also include supporting documentation, such as identification information, submitted as part of the application form 104.

The application form 104 includes one or more application fields (not shown), each potentially storing an application field value (not shown) provided by the Applicant 102. Application fields typically correspond to at least one question on the application form 104. The Applicant 102 provides an application field value within the application field in response to the question.

Once the Applicant 102 submits the application form 104 to the ABCS 106, the ABCS stores the application in the application data store 108. The Applicant 102 may then retrieve status from the ABCS to monitor progress on the Applicant's background check. If needed, the Applicant 102 may opt to provide supplementary information and/or corrections in his or her application form 104, and submit to the ABCS 106 for subsequent processing.

The ABCS 106 is administered by an Administrator 112 via an Administrator user interface such as a software client or a web page. Software clients and web pages are described in further detail with respect to FIGS. 2 and 3 below. The Administrator 112 is responsible for maintaining the ABCS 106 and generally ensuring the proper operation of the ABCS 106. Accordingly, the Administrator 112 will review one or more applications 114 stored in the application data store 108 as well as rules 116 stored in a rules data store 118 and validation data 120 stored in validation data store 122. Validation data 120 is retrieved from outside data sources 124 which are used to validate application field values reported by an Applicant 102.

Outside data stores 124 may include public online data sources, often in the form of social media and/or online services, or may include regulatory and/or private data stores and/or online services. An example of a social media service may include Facebook™ and Twitter™. Regulatory services may include criminal record databases, housing records, gun registration records, and data stores and/or services that are run by governmental agencies. Online services may include third party aggregators of background checks such as Intelius™. Many online services provide APIs to interface directly with their respective systems. In this way, the ABCS may correlate representations made by an Applicant 102 with online, public, and private data.

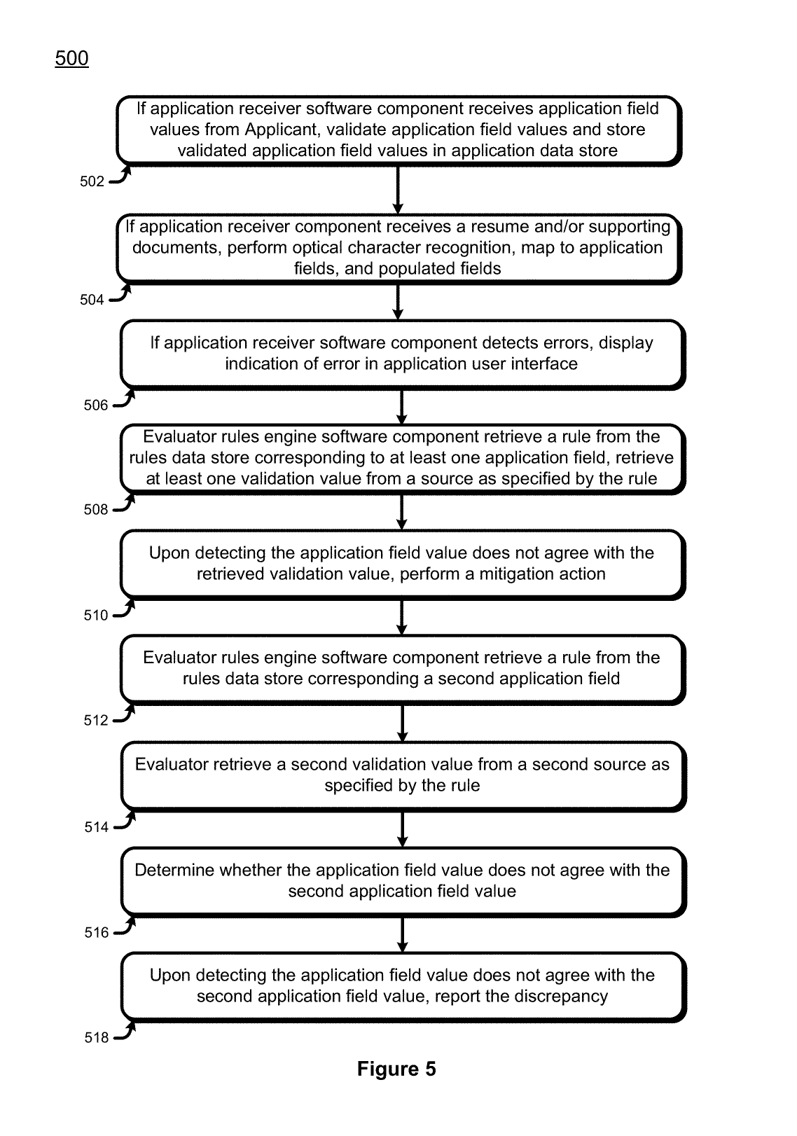

The Administrator 112 may either import rules 116 into rules data store 118 from an outside data store 124 via an Administrator user interface. Alternatively the Administrator 112 may modify or create rules 116 via a rules editor in the Administrator user interface. The rules editor is described in further detail with respect to FIG. 5 below.

The Administrator 112 may also review the results of investigations as stored in investigative data store 126. The Administrator 112 is responsible for setting access privileges for data and functionality within the ABCS 106. This includes the creation and management of accounts for users of the ABCS. Accordingly the Administrator 112 may limit access to the investigative data store 126 in order to comply with confidentiality and privacy rules.

Expanding on the outside data store 124, such data stores may include other instances of the ABCS in other jurisdictions and/or other similar background check data store systems in other jurisdictions. It is contemplated that different jurisdictions and services will use the ABCS architecture, and its ability to correlate applicant representations with outside data to perform a more comprehensive background check, and to enable pooling of background information. It is further contemplated that the ABCS architecture enables the pooling data among Federal, state, local government, and private security companies, subject to agreements between the parties. Sharing of data is discussed as a use case in later sections below.

Further note that the ABCS need not be utilized solely for law enforcement, but may be used for other background check contexts. This includes fire department service, teachers, and other service jobs sensitive to applicant backgrounds.

An investigation is performed by an Investigator 128, who reviews and investigates application forms 104 submitted by Applicant 102. The Investigator 128 interacts with the ABCS 106 via an Investigator user interface such as a software client or web page. Software clients and web pages are described in more detail with respect to FIGS. 2 and 3 below.

The Investigator 128 may retrieve application data 130 which comprise a subset of the data collected from Application forms 104 stored in the application data store 108. Similarly, the Investigator 128 may receive validation data 132 from the validation store 122 based on rules 116. The Investigator 128 will then perform various forms of analysis which may impact the application data 130. The investigative analysis results 134 are then stored into the investigatory data store 126.

Based on the investigative analysis results 134, the ABCS 106 may perform internal analysis and may report discrepancies in the application data 130 to the Investigator 128.

In this way, the collection of application data, validation data, investigation data, and even some portions of analysis is automated. Applications may be processed more quickly and discrepancies can be more quickly detected. Both data and results may be shared with other applications subject to security and privacy needs. Furthermore, the ABCS 106 encourages the cooperation between agencies in different jurisdictions by allowing those agencies to more easily share data and results in a consistent fashion.

### Exemplary Hardware, Software and Communications Environment for Automated Background Checks

### Computing Device

Prior to disclosing Automated Background Checks and related techniques, an exemplary hardware, software and communications environment is disclosed. FIG. 2 illustrates several possible embodiments of a hardware, software and communications environment 200 for Automated Background Checks and related techniques.

Client device 202 is any computing device. Exemplary computing devices include without limitation personal computers, tablet computers, smart phones, and smart televisions and/or media players.

Automated Background Checks and related techniques may be used in a number of platform contexts. Although Automated Background Checks and related techniques may be brought to bear on a typical networked client device 202 accessing a remote server, Automated Background Checks and related techniques alternatively may be implemented on a standalone computer. Accordingly, those techniques might be performed on a client device 202 that is a portable laptop, a mobile device, or a standalone station such as a kiosk.

A client device 202 may have a processor 204 and a memory 206. Client device 202's memory 206 is any computer-readable media which may store several software components including an application 208 and/or an operating system 210. In particular, the application 208 may be a client application comprising a software program that may be a web page or a networked application. The application 208 make comprise a set of software components.

In general, a software component is a set of computer executable instructions stored together as a discrete whole. Examples of software components include binary executables such as static libraries, dynamically linked libraries, and executable programs. Other examples of software components include interpreted executables that are executed on a run time such as servlets, applets, p-Code binaries, and Java binaries. Software components may run in kernel mode and/or user mode.

Computer-readable media includes, at least, two types of computer-readable media, namely computer storage media and communications media. Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transmission mechanism. As defined herein, computer storage media does not include communication media.

To participate in a communications environment, user equipment device 202 may have a network interface 212. The network interface 212 may be one or more network interfaces including Ethernet, Wi-Fi, or any number of other physical and data link standard interfaces. In the case where the user need only do operations on a standalone single machine, the network interface 212 is optional.

### Client-Server/Multi-Tier

Client 202, and in particular the application 208 may communicate to a server 216. Server 216 is any computing device that may participate in a network. The network may be, without limitation, a local area network (“LAN”), a virtual private network (“VPN”), a cellular network, or the Internet. The client network interface 212 may ultimate connect remote networked storage 214, or to server 216 via server network interface 218. Server network interface 218 may be one or more network interfaces as described with respect to client network interface 212.

Server 216 also has a processor 220 and memory 222. As per the preceding discussion regarding client device 202, memory 222 is any computer-readable media including both computer storage media and communication media.

In particular, memory 222 stores software which may include an application 224 and/or an operating system 226. Applications 224 may include server side applications 224 that communicate with client side applications 208.

Memory 218 may also store applications 224 that may include without limitation, an application server and a database management system. In this way, client device 202 may be configured with an application server and data management system to support a multi-tier configuration. Application servers may include web servers which serve web pages that may be served as web page client side applications 208 accessible via a web browser.

Server 216 may include a data store 228 accessed by the data management system. The data store 228 may be configured as a relational database, an object-oriented database, a NoSQL database, and/or a columnar database, or any configuration to support scalable persistence.

### Cloud

The server 216 need not be on site or operated by the client enterprise. The server 216 may be hosted in the Internet on a cloud installation 230. The cloud installation 230 may represent a plurality of disaggregated servers which provide virtual web application server 232 functionality and virtual database 234 functionality. Cloud 230 services 232, 234 may be made accessible via cloud infrastructure 236. Cloud infrastructure 236 not only provides access to cloud services 232, 234 but also billing services. Cloud infrastructure 236 may provide additional service abstractions such as Platform as a Service (“PAAS”), Infrastructure as a Service (“IAAS”), and Software as a Service (“SAAS”).

### System Internals for Automated Background Checks

As described above with respect to FIG. 1, the ABCS 106 has several interfaces to users and user entities (computer users) of the system. Specifically, the ABCS 106 interfaces with an Applicant 102, an Investigator 128, and an Administrator 112. Furthermore, the ABCS 106 may interface with outside user entities including outside data sources 302 and outside software applications 304. FIG. 3, is a block diagram 300 illustrating the interaction between the ABCS 106 and these users and user entities.

Applicant 102 accesses the ABCS 106 via an applicant user interface 306. The applicant user interface 306 may be in the form of a custom software application hosted on a computer or a mobile device. Alternatively, the applicant user interface 306 may be a web application hosted on a web application server on the cloud.

The applicant user interface 306 may present a plurality of fields to be completed by the Applicant 102, or alternatively may prompt the Applicant to upload a résumé and supporting documents. File transfer of the résumé and supporting documents may be implemented via File Transfer Protocol (FTP) for direct transfer, via Simple Mail Transfer Protocol (SMTP) via electronic mail or other similar internet protocols.

An application form 104 comprises a plurality of application fields, which store the answers to various questions describing the Applicant 102 and his or her activities, behaviors and/or past events relevant to the job or position. Where the applicant user interface 306 presents a plurality of fields, the Applicant 102 may directly enter application field values for each of the application fields. The completed fields are then aggregated and checked for data entry errors via an application receiver software component 308 which then subsequently stores the fields into application data store 108. Application fields that cannot be processed are then marked as improper in the applicant user interface 306 for correction by the Applicant 102.

In the alternative, the application receiver software component 308 may receive an uploaded résumé and the supporting documents from the applicant user interface 306. The application receiver software component 308 may then parse the uploaded résumé and the supporting documents, to populate the application form fields. The application receiver software component 308 may employ optical character recognition (OCR) for documents with handwritten data. The application receiver software component 308 then uses the parsed data as application form values and maps as entries for the application form fields, and subsequently stores those mapped values in application data store 108. Where an application form field does not have application field value from the résumé and the supporting documents, or values cannot be otherwise parsed or recognized via OCR, those application form fields are displayed to the Applicant 102 via the applicant user interface 306 for manual entry. Where the résumé and/or the supporting documents are received as a corrupted file, or where there is an upload error, the Applicant 102 may be prompted via the applicant user interface 306 to re-upload the résumé and/or the supporting documents.

Prior to providing information for the application form 104, Applicant 102, may submit a request to apply for a particular job or position via the applicant user interface 306. The request provides an Administrator 112 an opportunity to provide the Applicant 102 with a secure and auditable account to ensure that an Applicant is not making a fraudulent application under a false identity. The Administrator may dispatch an Investigator 128 to perform due diligence as to the identity of the Applicant 102. Upon the Investigator 128 validating the Applicant 102, the Administrator may provide the Applicant 102 with the secure and auditable account to access the applicant user interface 306.

An Administrator 112 may access the application data store 108 via an administrator user interface 310. The administrator user interface 310 has access to all the components and data stores comprising the ABCS 106. As with the applicant user interface 306, the administrator user interface 310 may be in the form of a custom software application hosted on a computer or a mobile device. Alternatively, the administrator user interface 310 may be a web application hosted on a web application server on the cloud.

In one embodiment, a request for an Applicant 102 to obtain an account is received via the application receiver component 308, and stored in application data store 108. The Administrator 112 will then view the request via administrator user interface 310. Upon notification from an Investigator 128 that the Applicant 102 has been validated, the Administrator 112 may send an account to Applicant 102 via the administrator user interface 310 via electronic mail or other communications protocol.

In general, the Administrator 112 is responsible for the proper operation and maintenance of the ABCS 106. Accordingly, the administrator user interface 310 may access all data stores and components comprising the ABCS 106. The Administrator 112, via the administrator user interface 310, may perform account management, privilege management, setting of rules for the evaluator software component rules engine 314, and audit of application forms via the administrator user interface 310.

Regarding account management and privilege management, the administrator user interface 310 accesses the underlying application server and/or database server to enable the Administrator 112 to add, remove and modify settings. In this way the administrator user interface 310 provides a convenience to the Administrator 112 in that the Administrator 112 need not access utilities specific to the underlying application server and/or database server to set accounts and privileges.

The evaluator software component rules engine 314, evaluates application forms according to rules stored in rules data store 118. The Administrator 112 may create new rules, edit existing rules and/or delete rules directly in the rules data store 118 via rules receiver software component 316 accessible via the administrator user interface 310. The rules receiver software component 316 provides create, retrieve, update and delete functionality in the rules data store 118. The administrator user interface 310 may provide an editor for which the Administrator 112 may edit rules. Those edits are then propagated to the rules data store 118 via the administrator user interface 310.

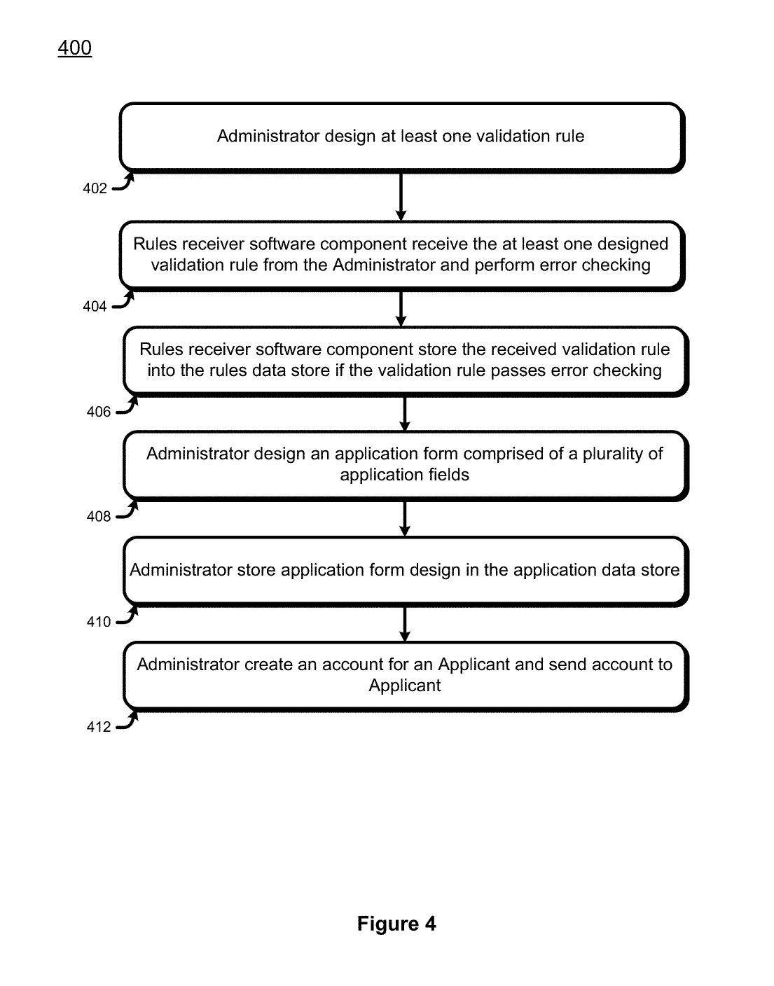

Additionally, the Administrator 112 may export a subset of a version of the rules stored in the rules data store 118 for backup, or to track versioning. Such exports may subsequently be uploaded to the rules data store 118 via rules receiver software component 316. The entering of rules by an Administrator 112 via the administrator user interface is described in further detail with respect to FIG. 4.

A subset may be chosen as a set of rules specific to a locality. Specifically, a locality is a geographical or organizational definition of the domain upon which a set of rules apply. A locality may be a jurisdiction, such as a specific municipal, county, or state jurisdiction. A locality may be organizational, such as a regulatory agency such as the Federal Bureau of Investigation which has Federal jurisdiction and therefore has jurisdiction in state, county, and municipal localities subject to rules. Another organizational locality may be an international regulatory organization such as Interpol which is defined by the operation of treaty. In this ways, exports may not only store rules, but may be associated with a locality.

The Administrator may audit application forms by generating reports from the administrator user interface 310, via report generator software component 312. The report generator software component 312 may generate statistics on applications submitted on demand via the administrator user interface 310. Example statistical reports may include counts and percentages of applicants accepted from total applicants, reasons for rejection, statistics subdivided by time period, demographic factors of the applicant, and events in common for applicants. The report generator software component 312 may interface with a machine learning component, potentially via application programming interface (API) 318, whereby applicants may be subdivided into categories. Statistical counts and percentages of applicants accepted from total applicants may then be subdivided into those machine learning generated categories. The operation of the API 318 described in further detail later in this section.

In addition to generating statistics, the report generator software component 312 may also retrieve one or more application field values for one or more application forms for display in the administrator user interface 310. Specifically, the administrator user interface 310 may include a query engine and/or query builder to perform search on application forms. In particular, an Administrator 112 and/or an Investigator 128 may review application form values or even entire application forms side by side via queries to the report generator software component. Reviewing applications by the Administrator 112 and/or an Investigator 128 is described in further detail with respect to FIG. 5.

An Investigator 128 interfaces with the ABCS 106 via an investigator user interface 320. As with the applicant user interface 306 and the administrator user interface 310, the investigator user interface 320 may be in the form of a custom software application hosted on a computer or a mobile device. Alternatively, the investigator user interface 320 may be a web application hosted on a web application server on the cloud.

The investigator user interface 320 is used to access applications and results of analysis from the evaluator software component rules engine 314, augmented with data from outside data sources 302, evaluated in view of rules input by the Administrator 112. In particular the Investigator 128 retrieves applications from the application store 108, and enters data into the investigatory store 126 based on investigatory activity. Investigatory activity may include personal interviews, physical fact checking, and other efforts to find corroboration to representations made in an application.

One of the advantages of the ABCS 106 is the automation of much of this corroborative work. Without ABCS 106, an Investigator 128 is obliged to check each and every representation in an application physically, which may involve several time consuming trips. Instead, with ABCS 106, an Investigator 128 may prioritize investigatory activity based on information gleaned on data already existing on the Applicant 102, much left by the Applicant 102 himself or herself.

This is accomplished by the retrieval by the evaluator software component rules engine 314 retrieving data from outside data sources 302 via API 318, and determining both agreement and discrepancy between an application and the retrieved data. Outside data sources 302 may include databases accessible either by the public, or by law enforcement, generally published by regulatory agencies. Public records may include residential information, licensing information, prior job applications, criminal records, and other court records. Other information is available via outside data sources 302 that do not involve direct access of a data source. Examples includes social network applications, and public posts by an Applicant 102 such as Facebook™ and Twitter™ where data access on outside data sources 302 may be via a prescribed API exposed by a web service and web application.

The API 318 for the ABCS 106 also enables access of data by outside applications 304. An outside application 304 is generally an application from another law enforcement or regulatory seeking to corroborate information on individuals. The outside application 304 may be an ABCS 106 from another jurisdiction.

As an investigation on an application progresses, the Investigator 126 continues to populate the investigatory store 126 and evaluator software component rules engine 314 continues to retrieve data from outside data sources 302 to populate the validation store 122. If an application 108 contains a data value input for a data field input by an Applicant 102 where there is a discrepancy per a rule in rules store 118, then the investigatory component 322 is used to notify the Investigator 128 via investigator user interface 320. In this way, the Investigator 128 may focus attention on that discrepancy and thereby prioritize their investigatory activities. This process is described in further detail with respect to FIG. 5.

### Administrator Functional Operation for Automated Background Checks

An Administrator 112 ensures the proper operation of the ABCS 106. Some of activities of the Administrator include the maintenance of rules used by the evaluator software component rules engine 314, the design and upload of application forms, and the creation of secure and auditable accounts for use by an Applicant 102. FIG. 4 is a flow chart 400 of these activities.

In block 402, an Administrator designs at least one validation rule. The validation rule may be edited by the Administrator 112 in a rules editor in the administrator user interface 310. The rules editor may reference particular fields in a form and specify rules to determine discrepancies. Rules to be specified include consistency checks between a field and: (i) a lookup list of predetermined values, (ii) other fields in the application, (iii) data values from outside data sources 302, and (iv) results from a physical investigatory activity.

In many cases, there will not be a one-to-one data value to data value corroboration check. In some cases, multiple fields may have to be transformed, combined, and mapped to a field in an application to be corroborated. For example, a field may include an address, but corroborative data may be subdivided into a street address, state, and ZIP code. In some cases, synonym values may have to be generated. For example a person may have a formal first name of “James”, but have multiple postings under a nickname or contracted name such as “Jim.”

In some cases a rule may look for logic for example in the agreement of dates or statistical analysis. In yet other cases, a rule may delegate machine learning or other similar analysis to determine whether the behavior patterns as represented by an Applicant 102 are likely.

Where logical operations are specified in a rule, there is a risk that a rule designed by the Administrator 112 may have errors. Accordingly in block 404 the rules receiver 316 performs a consistency check on the rule. Consistency checks may look for common logical errors such as tautologies. Consistency checks may run the rule against a set of test applications seeded with known consistency errors, to determine if the expected errors are detected. Upon validation of the rule, in block 406, the rules receiver 316 uploads the designed rule in to the rules data store 118 for use by the evaluator software component rules engine 314.

Turning to the activity of creating application forms, an Administrator 112 will use a forms editor in the administrator user interface 310 to translate the original paper forms used for applications for a jurisdiction into a web page or software form. In the forms editor, the Administrator 112 will convert single fields into text fields, combo and/or list boxes, radio buttons, check boxes and the like. The Administrator 112 may preview the edited form in the forms editor. In addition to editing the functionality of the software form, the Administrator 112 may modify the look and feel (aesthetics) of the software form such as organizing placement of fields and adding logos, background patterns and coloring/shading. Upon completion of the forms design, in block 410 the Administrator then uploads the software form to the application forms data store 108.

An Administrator 112 also sets access privileges for users of the ABCS. This includes the creation of user accounts for other Administrators 112 and for Investigators 128. Administrators 112 and/or Investigators may have granted or denied access according to access control lists on a per function and/or per data basis. For example, some Administrators 112 may be restricted from access from the forms editor and/or the rules editor functions. By way of another example, Investigators 128 and/or Administrators 112 may be restricted from viewing particular applications or even particular fields of an application. In this way, the ABCS provides for walling off sensitive and private data on a need to know basis on a per function and per field basis.

In block 412, Applicants 102 are granted access by an Administrator 112 via a secure and auditable account. The Administrator 112 creates an account for an Applicant 102 limited to the accessing the Applicant's application form. The account may be set to expire within a predetermined time period. The form may present dialog box during logon where the Applicant 102 presents multiple factor authentication credentials to further ensure the identity of the Applicant 102. The software form may be configured to track whether the Appliance 102 repeatedly edits field, perhaps in an effort to fabricate a persona.

The Administrator 112 is not limited to the foregoing functions. Rather the above is illustrative of functions that the Administrator 112 may perform to maintain the operation of an ABCS 106.

### Investigator Functional Operation for Automated Background Checks

Performing an investigation on an Applicant 102 is an interactive process. An Investigator 128 is constantly reviewing representations made by an Applicant 102 and performing investigatory actions to verify those representations and populating the investigatory data store 126. The evaluation software component rules engine 314 is updating and/or refreshing the validation data store 122 with data from outside data stores 302. As the incoming data in the investigatory data store 126 and validation data store 122 changes, the evaluation software component rules engine may detect discrepancies to report to the Investigator. FIG. 5 illustrates this process in flow chart 500.

In block 502, an Applicant 102 provides either a paper application subjected to optical character recognition (OCR) or fills out an electronic form in an applicant user interface 306. In application field values input by the Applicant 102 are subjected to error checking, such as typographical and formatting errors, as described above with respect to FIG. 3. Upon validation, and potentially upon received corrections from the Applicant 102, in block 504, the applicant user interface 306 forwards the application field values to the application receiver component 308. The application receiver component 308, based on rules in the rules data store 118 maps the incoming application field values to the application form. In some cases, the application form may be automatically populated by the application receiver component 308, for example ZIP code based on city and street information.

If the application receiver component 308 detect logical errors, then in block 506 those errors are reported to the Applicant 102 via the applicant user interface 306 for correction. In some embodiments, errors detected during block 502 and block 504 may be combined and displayed to the Applicant 102 at the same time, rather than piecemeal. The application receiver component 308 then stores the application along with any corrections to the application data store 108. The application receiver component 308 is to keep an auditable trail of changes to the application. Accordingly, the application receiver component 308 may track corrections rather than overwrite previous application field values. In this way an Administrator 112 or Investigator 128 perform subsequent analysis to detect potential patterns of manipulation by an Applicant 102.

At any time, the evaluator software component rules engine 314 may perform a validation check on an application. This may occur in block 508 where the evaluator software component rules engine 314 selects a field to validate. The selection may be done at the time an application is received or the evaluator software component rules engine 314 may determine that either new data in the investigatory data store 126 and/or the validation store may be used to validate a field. A rule typically will specify an application field and the ways that a data value in the investigatory data store 126 and/or a data value in the validation store 122 may be used to validate the value of the application field. Specifically, whenever a change field for an existing application the evaluator software component rules engine 314 perform a validation check.

Alternatively, whenever a value is added or changed in the validation store 122 or a value in the investigatory store 126 the evaluator software component rules engine 314 retrieves any rules in the rules data store 118 that make use of the changed value. The evaluator software component rules engine 314 then performs the any application field values that the retrieved rule specifies may be validated with those changed values.

The evaluator software component rules engine 314 may detect a discrepancy. In block 510, if a discrepancy is detected, the evaluator software component rules engine 314 may perform a mitigation action. In some cases, a mitigation action may be a request for clarification from an Applicant 102. For example, an Applicant may have been left a field incompletely or vaguely answered. In other cases, a mitigation action may be for an Investigator 128 to determine whether a physical investigatory action is to be taken. In other situations, for administrative or procedural rather than substantive purposes, the evaluator software component rules engine 314 may perform an automatic correction. The changes to the application data store may be tracked and versioned for auditability as described above.

In some cases, an application may be evaluated for internal consistency. Some rules may track dependencies between application fields. For example, if an Applicant 102 reports that they were actively employed by the New York City Police Department from 1985 to 1995, it is unlikely that that same person could report that they were Gulf War veteran at the same time.

For those cases, the evaluator software component rules engine 314 may detect either a change in an application field value, or may detect an application field value was determined to have a discrepancy. The evaluator software component rules engine 314 then retrieves rules that determine dependencies between application field values and then performs the validation checks in those rules. In this way, the ABCS 106 not only checks individual application fields, but triggers checks on other application fields that may be suspect if a discrepancy in other fields is detected.

In block 514, to perform the rules retrieved in block 512, values from the investigatory data store 126 and/or the validation store 122 are retrieved as specified in the retrieved rules. In block 516, the evaluator software component rules engine 314 performs validation checks as specified.

In block 518 any discrepancy detected by the evaluator software component rules engine 314 is reported to the Investigator 128 via the investigatory component 322 and the investigator user interface 320. Types of discrepancies may include: (i) an application field value does not agree with another application field value, (ii) an application field value does not agree with a value (called a validation value) in the investigatory store 126 or the validation store 122, and (iii) or values relating to a second rule.

Some discrepancies may be more severe than others. Application fields that are procedural rather than substantive may be deprioritized. Accordingly, an Investigator 128 may opt to set a predetermined threshold where only discrepancies with a degree of severity above that predetermine threshold are displayed to the Investigator 128 at that time. In this way, an Investigator 128 may opt to focus on the most serious discrepancies.

### ABCS as a Data Sharing Facility

The ABCS 106 enables an Investigator 128 to perform an automated background check on an Applicant 102, where the representations made by Applicant 102 are not only directly investigated, but are cross-checked against third party data. Third party data, as described above, may include a wide range of structured and semi-structured data, generally available online. Third party data may even include ABCS's in other jurisdictions and/or other background check applications. Accordingly, the ABCS 106 may be seen as an aggregator of third party data about applicants. This gives rise to some data sharing use cases for the ABCS 106.

First of all, the ABCS 106 may be accessed for background checks for other types of jobs or services. Because the ABCS 106 may have a comprehensive aggregation about third party data, the ABCS 106 may be used for fire departments, teachers, social workers, or other positions of trust. In these circumstances, the application store 108 and the rules store 118 may store information to reflect the needs of those other types of jobs or services. In general, the ABCS 106 need not be limited to law enforcement, but may be used for commercial companies or for the general public as well. For example, Intellius™ may seek to include an ABCS 106 as one of its constituent background checks.

The ABCS 106 may also be used to aggregate data across jurisdictions. It is not unusual for a police applicant to be rejected in one jurisdiction, and then to apply in a second jurisdiction, where the second jurisdiction is not aware of the first application. However, Federal, State, Local, and even private security companies may agree to share data. Accordingly, and ABCS 106 may store each of the background data stores as outside data stores 124, and the rules store 118 may contain information to cross check during a background check. The rules store 118 may also contain rules as to when a cross check is permissible, to enforce any background data sharing restrictions between the different jurisdictions.

Also, because the ABCS 106 may have multiple data stores from different jurisdictions, it can correlate data from those different jurisdictions. One scenario is to update prior background checks that were conducted without benefit of the ABCS 106. In this way, errors in prior background checks may be detected. Another use case is to check for inconsistencies in other background check data. Specifically, where representations in one data store do not agree with another, the Administrator 112 may be provided a report from the ABCS 106 to indicate discrepancies for correction.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of validating field values, comprising:
receiving an application comprised of a plurality of application fields;
receiving at least one application field value for an applicant, the application field value corresponding to one of the plurality of application fields;
receiving at least one validation rule, the at least one validation rule configured to specify at least one validation value accessible from a specified source, wherein a value of an application field is to agree with the specified at least one validation value;
storing the received at least one validation rule;
retrieving the specified at least one validation value from the specified source; and
determining if the received at least on application field value agrees with retrieved at least one validation value according to the stored at least one validation rule.

2. The method of claim 1, comprising: determining that the received at least one application field value is either empty or incomplete, and populating the application field value with a value based at least on the retrieved at least one validation value based at least on the stored at least one validation rule.

3. The method of claim 1, comprising: determining that the received at least one application field value is either empty or incomplete, and recommending an alternative source of information for the at least one application based at least on the stored at least one validation rule.

4. The method of claim 1, wherein the determining if the received at least one application field value agrees with retrieved at least one validation value is based on a derived value based on the received at least one validation value based at least on the stored at least one validation rule.

5. The method of claim 1, wherein the specified source is an online source.

6. The method of claim 5, wherein the online source is a social network.

7. The method of claim 1, wherein the received at least one validation rule is received along with a set comprised of a plurality of validation rules designated to a locality.

8. The method of claim 7, wherein the specified source is from a locality different that the locality of the locality designated for the received set of validation rules.

9. The method of claim 7, wherein the specified source is a law enforcement database.

10. The method of claim 7, wherein the set of validation rules is for performing a background check for a law enforcement officer.

11. The method of claim 7, wherein the set of validation rules is for any one of the following:
performing a background check for a fire department employee;
performing a background check for a teacher for a minor;
performing a background check for a youth worker; or
performing a background check for a regulatory worker.

12. The method of claim 1, comprising: reporting a discrepancy in the received at least one application field value.

13. The method of claim 12, wherein the discrepancy is a discrepancy between the received at least one application field value and the retrieved at least one validation value based at least on the stored at least one validation rule.

14. The method of claim 1, comprising:
receiving a second application field value;
receiving a second validation rule, the second validation rule configured to specify a second validation value accessible from a second specified source, wherein the value of the second application field is to agree with the specified second validation value;
storing the received second validation rule; and
retrieving the specified second validation value from the specified second source; and
wherein the reported discrepancy is a discrepancy between the received at least one application field value and the second application field value, based on at least one of the received at least one validation rule and the second validation rule.

15. The method of claim 12, wherein the degree of the reported discrepancy includes an indication that the reported discrepancy exceeds a predetermined threshold.

16. The method of claim 1, comprising: determining that the received at least one application field value was not responsive based on based on the received at least one validation value based at least on the stored at least one validation rule.

17. A method to manage application data, comprising:
receiving a first application comprised of a plurality of application fields;
storing the received first application;
receiving a second application comprised of a plurality of application fields;
storing the received second application;
receiving a set of a plurality of validation rules, each validation rule configured to specify at least one validation value accessible from a specified source, wherein a value of at least one application field is to agree with the specified at least one validation value;
determining whether one of the plurality of application fields in the first application agrees with at least one validation rule of the received set of validation rules, and determining whether one of the plurality of application fields in the second application agrees with at least one validation rule of the received set of validation rules; and
generating an administrative report on the determination of the first application and the determination of the second application.

18. The method of claim 17, wherein the set of validation rules is specific to a locality.

19. The method of claim 18, wherein the administrative report is accessible to a jurisdiction different than the locality.

20. A system to manage application data, comprising:
a processor;
a memory, communicatively coupled to the processor;
an application receiving software component, resident in the memory, configured to receive at least one application form comprised of a plurality of application fields;
an application data store, communicatively coupled to the processor, configured to store at least one application form received by the application receiving software component;
a rules receiving software component, resident in the memory, configured to receive at least one validation rule, the at least one validation rule configured to specify at least one validation value accessible from a specified source, wherein a value of an application field is to agree with the specified at least one validation value;
a rules data store, communicatively coupled to the processor, configured to store at least one validation rule received by the rules receiving software component;
an evaluator software component, resident in the memory, configured to apply at least one validation rule stored in the rules data store to at least one application field in an application stored in the application data store; and
a reporting software component configured to generate a report of a result of at least one evaluation performed by the evaluator software component.
